(19) United States
(12) Patent Application Publication
(10) Pub. No.: US 2024/0035333 A1
(43) Pub. Date: Feb. 1, 2024

(54) PET DOOR ASSEMBLY

(71) Applicant: Tom Garner, Hillsborough, NC (US)

(72) Inventor: Tom Garner, Hillsborough, NC (US)

(21) Appl. No.: 18/360,220

(22) Filed: Jul. 27, 2023

Related U.S. Application Data
(60) Provisional application No. 63/392,768, filed on Jul. 27, 2022.

(51) Int. Cl. E06B 7/32

(52) U.S. Cl. CPC E06B 7/32

(57) ABSTRACT

A pet door assembly allowing ingress and egress of a pet to a shelter or housing is disclosed. while protecting the opening of the shelter or housing from being damaged from chewing by the pet, wherein the pet door assembly further includes an awning for minimizing the ability of rain or other precipitation from entering the opening of the pet door assembly and wherein the pet door assembly further includes a gap between the flap and the frame allowing the shelter or housing to maintain the pet's body heat without buildup of moisture and carbon dioxide from the pet's respiration on the inside of the shelter or housing.

### BACKGROUND

Pets, such as dogs, cats, and other domesticated animals often need shelter from the elements, including cold or hot temperatures, and precipitation, including rain, sleet, ice, snow, hail and the like. To allow ingress and egress from the shelter and to protect the pet, the pet's bedding, and the like from the elements, some type of pet door assembly is required. There is a need in the art, however, for simple and effective pet door assemblies.

### SUMMARY

In some aspects, the presently disclosed subject matter provides a pet door assembly comprising: (a) a frame defining a through-opening; (b) a flap pivotally connected to the frame via a plurality of clips, wherein the flap is operatively positioned within the through-opening and is configured to cover a substantial portion of the through-opening, and wherein the flap comprises a front surface and a back surface; (c) wherein the plurality of clips are configured to maintain the flap in a substantially closed orientation absent external forces applied to the front surface or back surface of the flap; and (d) wherein a predetermined force is required to be applied to the front surface or back surface of the flap to pivot the flap in a substantially open orientation.

In certain aspects, the pet door assembly further comprises a gap between the frame and a top portion, bottom portion, side portion, and opposite side portion of the flap.

In certain aspects, the plurality of clips comprises a c-clip. In particular aspects, the c-clip further comprises an inward directed tab positioned on a distal and proximate end thereof. In more particular aspects, the plurality of clips is operably attached to the frame and to the flap through a plurality of holes in the frame and the flap, respectively.

In certain aspects, the flap has a shape selected from a square, a rectangle, an oval, and a circle.

In certain aspects, the pet door assembly comprises an awning attached to an upper portion of the frame, wherein the awning is positioned substantially perpendicular to a forward face of the frame, and wherein the awning is configured to substantially prevent precipitation from entering the through-opening.

In certain aspects, the flap allows ingress or egress when the flap is in a substantially open position and reverts to a substantially closed position when an external force is no longer applied to the front surface or back surface of the flap.

In certain aspects, the pet door assembly is configured to be attached to a pet shelter or housing. In particular aspects, the pet shelter or housing is selected from a 55-gallon drum, a conventional dog house, a shed, a garage, and a residential home.

Certain aspects of the presently disclosed subject matter having been stated hereinabove, which are addressed in whole or in part by the presently disclosed subject matter, other aspects will become evident as the description proceeds when taken in connection with the accompanying Examples and Figures as best described herein below.

### BRIEF DESCRIPTION OF THE FIGURES

The patent or application file contains at least one drawing executed in color. Copies of this patent or patent application publication with color drawing(s) will be provided by the Office upon request and payment of the necessary fee.

Having thus described the presently disclosed subject matter in general terms, reference will now be made to the accompanying Figures, which are not necessarily drawn to scale, and wherein:

FIG. 1 is a front view of a representative presently disclosed pet door assembly; and

FIG. 2 is one embodiment of a clip suitable for use with the presently disclosed pet door assembly.

### DETAILED DESCRIPTION

The presently disclosed subject matter now will be described more fully hereinafter with reference to the accompanying Figures, in which some, but not all embodiments of the inventions are shown. Like numbers refer to like elements throughout. The presently disclosed subject matter may be embodied in many different forms and should not be construed as limited to the embodiments set forth herein; rather, these embodiments are provided so that this disclosure will satisfy applicable legal requirements. Indeed, many modifications and other embodiments of the presently disclosed subject matter set forth herein will come to mind to one skilled in the art to which the presently disclosed subject matter pertains having the benefit of the teachings presented in the foregoing descriptions and the associated Figures. Therefore, it is to be understood that the presently disclosed subject matter is not to be limited to the specific embodiments disclosed and that modifications and other embodiments are intended to be included within the scope of the appended claims.

In some embodiments, the presently disclosed subject matter provides a pet door assembly allowing ingress and egress of a pet to a shelter or housing. In one embodiment, the presently disclosed pet door assembly protects the opening of the shelter or housing from being damaged from chewing by the pet. In another embodiment, the pet door assembly includes an awning for minimizing the ability of rain or other precipitation from entering the opening of the pet door assembly. Importantly, the presently disclosed pet door assembly includes a gap between the flap and the frame allowing the shelter or housing to maintain the pet's body heat without buildup on the inside of the shelter or housing of moisture and carbon dioxide from the pet's respiration.

The presently disclosed pet door assembly can be easily removed during hotter days or to otherwise allow access to the shelter or housing without disassembling the entire frame. The clips prevent the flap from binding a pet stuck halfway in or out of the pet door assembly. Further, the design of the presently disclosed pet door assembly facilitates an efficiency of manufacturing such that a single machine can fabricate the flap and frame from a single sheet of material, e.g., stainless steel.

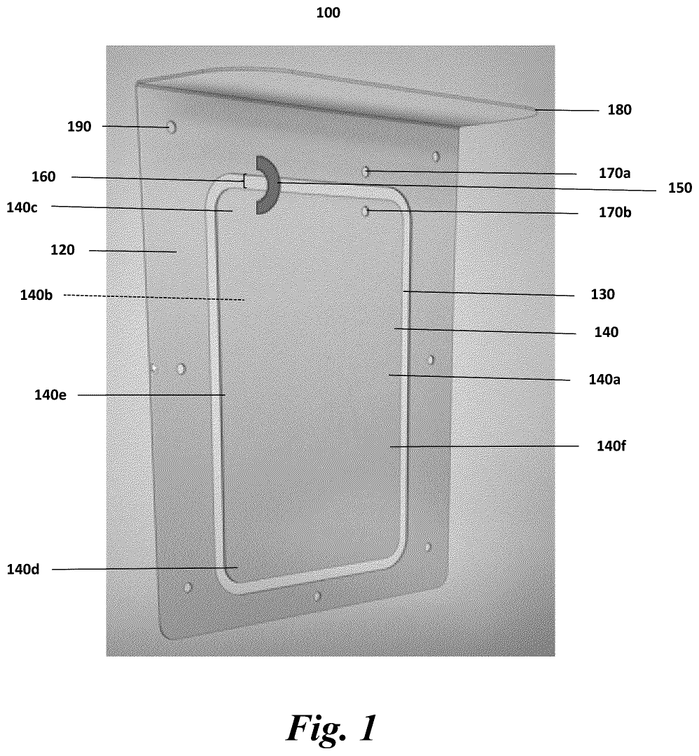

Referring now to FIG. 1 is a representative pet door assembly 100 for pet shelter or housing 110. Pet door assembly 100 includes a frame 120 comprising a through opening 130. Pet door assembly 100 further includes a flap 140 pivotally connected to frame 120 via a plurality of clips 150. Flap 140 is operably positioned within through-opening 130 and is configured to cover a substantial portion of through-opening 130. Flap 140 comprises a front surface 140a, a back surface 140b, a top portion 140c, a bottom portion 140d, a side portion 140e, and an opposite side portion 140f. When flap 140 is operably positioned within through-opening 130, there exists a gap 160 between frame 120 and top portion 140c, bottom portion 140d, side portion 140e, and opposite side portion 140f. As provided hereinabove, gap 160 allows shelter or housing 110 to maintain the pet's body heat without buildup on the inside of shelter or housing 110 of moisture and carbon dioxide from the pet's respiration.

Referring once again to FIG. 1, the plurality of clips 150 are configured to maintain flap 140 in a substantially closed orientation absent external forces applied to the front surface 140a or back surface 104b of the flap 140. A predetermined force is required to be applied to the front surface 140a or back surface 140b of flap 140 to pivot the flap 140 in a substantially open orientation.

In certain embodiments, the plurality of clips 150 are operably attached to frame 120 and flap 140 through a plurality of holes 170a and 170b in the frame 120 and the flap 140, respectively. Although a rectangular shape is shown for illustrative purposes only, flap 140 can have a shape selected from a square, a rectangle, an oval, and a circle.

Referring once again to FIG. 1, pet door assembly 100 can further comprise an awning 180 attached to an upper portion 120a of frame 120, wherein awning 180 is positioned substantially perpendicular to a forward face 120b of frame 120. Awning 180 is configured to substantially prevent precipitation, e.g., rain, sleet, ice, snow, hail, and the like, from entering through-opening 130.

In some embodiments, flap 140 allows ingress or egress from pet shelter or housing 110 when the flap 140 is in a substantially open position and reverts to a substantially closed position when an external force is no longer applied to the front surface 140a or back surface 140b of flap 140.

As illustrate in FIG. 1, in some embodiments, pet door assembly 100 is configured to be attached to a pet shelter or housing 110 through holes 190 by any attachment means known in the art, such as a screw, a nail, a rivet, and the like. In certain embodiments, pet shelter or housing 110 is selected from a 55-gallon drum, a conventional dog house, a shed, a garage, and a residential home.

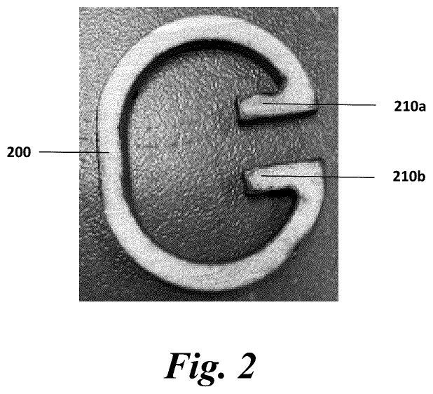

Referring now to FIG. 2, in some embodiments, the plurality of clips 150 comprises a c-clip 200. Referring once again to FIG. 2, in some embodiments, c-clip 200 further comprises an inward directed tab 210a and 210b positioned on a distal and proximate end thereof.

Following long-standing patent law convention, the terms “a,” “an,” and “the” refer to “one or more” when used in this application, including the claims. Thus, for example, reference to “a subject” includes a plurality of subjects, unless the context clearly is to the contrary (e.g., a plurality of subjects), and so forth.

Throughout this specification and the claims, the terms “comprise,” “comprises,” and “comprising” are used in a non-exclusive sense, except where the context requires otherwise. Likewise, the term “include” and its grammatical variants are intended to be non-limiting, such that recitation of items in a list is not to the exclusion of other like items that can be substituted or added to the listed items.

For the purposes of this specification and appended claims, unless otherwise indicated, all numbers expressing amounts, sizes, dimensions, proportions, shapes, formulations, parameters, percentages, quantities, characteristics, and other numerical values used in the specification and claims, are to be understood as being modified in all instances by the term “about” even though the term “about” may not expressly appear with the value, amount or range. Accordingly, unless indicated to the contrary, the numerical parameters set forth in the following specification and attached claims are not and need not be exact, but may be approximate and/or larger or smaller as desired, reflecting tolerances, conversion factors, rounding off, measurement error and the like, and other factors known to those of skill in the art depending on the desired properties sought to be obtained by the presently disclosed subject matter. For example, the term “about,” when referring to a value can be meant to encompass variations of, in some embodiments, ±100% in some embodiments ±50%, in some embodiments ±20%, in some embodiments ±10%, in some embodiments ±5%, in some embodiments ±1%, in some embodiments ±0.5%, and in some embodiments 0.1% from the specified amount, as such variations are appropriate to perform the disclosed methods or employ the disclosed compositions.

Further, the term “about” when used in connection with one or more numbers or numerical ranges, should be understood to refer to all such numbers, including all numbers in a range and modifies that range by extending the boundaries above and below the numerical values set forth. The recitation of numerical ranges by endpoints includes all numbers, e.g., whole integers, including fractions thereof, subsumed within that range (for example, the recitation of 1 to 5 includes 1, 2, 3, 4, and 5, as well as fractions thereof, e.g., 1.5, 2.25, 3.75, 4.1, and the like) and any range within that range.

Although the foregoing subject matter has been described in some detail by way of illustration and example for purposes of clarity of understanding, it will be understood by those skilled in the art that certain changes and modifications can be practiced within the scope of the appended claims.

That which is claimed:

1. A pet door assembly comprising:
(a) a frame defining a through-opening;
(b) a flap pivotally connected to the frame via a plurality of clips, wherein the flap is operatively positioned within the through-opening and is configured to cover a substantial portion of the through-opening, and wherein the flap comprises a front surface and a back surface;
(c) wherein the plurality of clips are configured to maintain the flap in a substantially closed orientation absent external forces applied to the front surface or back surface of the flap; and
(d) wherein a predetermined force is required to be applied to the front surface or back surface of the flap to pivot the flap in a substantially open orientation.

2. The pet door assembly of claim 1, further comprising a gap between the frame and a top portion, bottom portion, side portion, and opposite side portion of the flap.

3. The pet door assembly of claim 1, wherein the plurality of clips comprises a c-clip.

4. The pet door assembly of claim 3, wherein the c-clip further comprises an inward directed tab positioned on a distal and proximate end thereof.

5. The pet door assembly of claim 1, wherein the plurality of clips is operably attached to the frame and to the flap through a plurality of holes in the frame and the flap, respectively.

6. The pet door assembly of claim 1, wherein the flap has a shape selected from a square, a rectangle, an oval, and a circle.

7. The pet door assembly of claim 1, further comprising an awning attached to an upper portion of the frame, wherein the awning is positioned substantially perpendicular to a forward face of the frame, and wherein the awning is configured to substantially prevent precipitation from entering the through-opening.

8. The pet door assembly of claim 1, wherein the flap allows ingress or egress when the flap is in a substantially open position and reverts to a substantially closed position when an external force is no longer applied to the front surface or back surface of the flap.

9. The pet door assembly of claim 1, wherein the pet door assembly is configured to be attached to a pet shelter or housing.

10. The pet door assembly of claim 9, wherein the pet shelter or housing is selected from a 55-gallon drum, a conventional dog house, a shed, a garage, and a residential home.
